(19) United States
(12) Patent Application Publication
(10) Pub. No.: US 2026/0304343 A1
(43) Pub. Date: Oct. 1, 2026

(54) Methods for Enabling AI-agent Discovery and Inter-AI-agent Communication for Next Generation Wireless Network

(71) Applicant: InterDigital Patent Holdings, Inc., Wilmington, DE (US)

(72) Inventors: Guanzhou Wang, Brossard (CA); Ulises Olvera-Hernandez, Saint-Lazare (CA); Jung Je Son, Warrington, PA (US); Taimoor Abbas, Sainte-Julie (CA); Michel Roy, Candiac (CA); Alec Brusilovsky, Downingtown, PA (US)

(73) Assignee: InterDigital Patent Holdings, Inc., Wilmington, DE (US)

(21) Appl. No.: 19/092,020

(22) Filed: Mar. 27, 2025

(51) Int. Cl. H04W 60/04; H04L 41/16; H04W 8/22; H04W 80/06

(52) U.S. Cl. CPC H04W 60/04; H04L 41/16; H04W 8/22; H04W 80/06

(57) ABSTRACT

A wireless transit/receive unit (WTRU) may include a processor and a memory. The WTRU may be configured to send a registration request to a network. The registration request may indicate capability of the WTRU to support one or more artificial intelligence (AI) agents. The WTRU may be configured to receive AI-agent anchor information from the network. The AI-agent anchor information may indicate an AI-agent anchor residing in the network. The WTRU may be configured to establish a connection with the AI-agent anchor. The WTRU may be configured to send a protocol data unit (PDU) session request via the connection to the AI-agent anchor using a WTRU-side AI-agent. The WTRU may be configured to receive network-side AI-agent information corresponding to the PDU session request from a network-side AI-agent. The network-side AI agent information may include AI-agent ID and/or metadata associated with the network-side AI-agent.

### BACKGROUND

With the breakthrough and fast progress of the artificial intelligence (AI) technology in recent years, the designers of the next generation wireless network (e.g., 6G System) envision an “AI Native” system architecture. Instead of having AI functionalities in a centralized network entity, like network data analytics function (NWDAF) in 5G core (5GC), AI functionalities or AI-enabled algorithm may be distributed across the whole network ecosystem, including the user equipment, radio access networks (RANs), core network functions, application servers, business support system (BSS) and operation administration and management (OAM).

### SUMMARY

A wireless transit/receive unit (WTRU) may include a processor and a memory. The WTRU may be configured to send a registration request to a network. The registration request may indicate capability of the WTRU to support one or more artificial intelligence (AI) agents. The WTRU may be configured to receive AI-agent anchor information from the network. The AI-agent anchor information may indicate an AI-agent anchor residing in the network. The WTRU may be configured to establish a connection with the AI-agent anchor. The WTRU may be configured to send a protocol data unit (PDU) session request via the connection to the AI-agent anchor using a WTRU-side AI-agent. The PDU session request may indicate a purpose of the connection and/or a reserved data network name (DNN) for the purpose. The WTRU may be configured to receive network-side AI-agent information corresponding to the PDU session request from a network-side AI-agent. The network-side AI agent information may include AI-agent ID and/or metadata associated with the network-side AI-agent.

The registration request may indicate a task that is supported by the WTRU and/or that the WTRU supports an inter-agent communication.

The WTRU may be configured to initiate a default PDU session establishment for an inter-agent communication.

The AI-agent anchor information may include an address associated with the AI-agent and/or security information. The AI-agent anchor may be a connection anchor between multiple WTRU-side AI-agents and multiple network-side AI-agents. The AI-agent anchor may be hosted by an access and mobility management function (AMF) of the network, a user plane function (UPF) of the network, and/or a session management function (SMF) of the network.

The connection between the WTRU-side AI-agent and the AI-agent anchor may be a quick user datagram protocol (UDP) internet connection (QUIC). The connection between the WTRU-side AI-agent and the AI-agent anchor may include a first connection between the WTRU-side AI-agent and an AI-agent hub, and/or a second connection between the AI-agent hub and the AI-agent anchor. The AI-agent hub may be a connection anchor between multiple WTRU-side AI-agents and the AI-agent anchor.

The WTRU may be configured to receive a request from the network to create a second WTRU-side AI-agent for quality of service (QOS) control. The WTRU may be configured to communicate with a second network-side AI-agent to perform QoS control activities

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example framework for inter-AI-Agent communication across the network ecosystem for various tasks.

FIG. 3 illustrates an example procedure of AI-agent Anchor hosted by the WTRU's serving access and mobility management function (AMF).

FIG. 4 illustrates an example procedure of the AI-agent Anchors hosted by the WTRU's user plane function (UPF).

FIGS. 5A and 5B are flow charts to illustrate a high-level example procedure which enables interactions among AI-agents from WTRU-side and CN-side for session management and quality of service (QoS) control.

FIG. 6 is a flow chart to illustrate an example procedure of AI-agent information exchange via AI-agent anchor.

FIG. 7 illustrates an example procedure of AI-agent repository.

FIG. 8 is a flow chart to illustrate an example procedure on how the WTRU obtains AI-agent information from the AI-agent repository.

FIG. 9 illustrates an example procedure of direct inter-agent connection.

FIG. 10 illustrates an example procedure of indirect inter-agent connection via AI-agent anchor.

FIG. 11 illustrates an example procedure of indirect inter-agent connection via AI-agent hub and AI-agent anchor.

### DETAILED DESCRIPTION

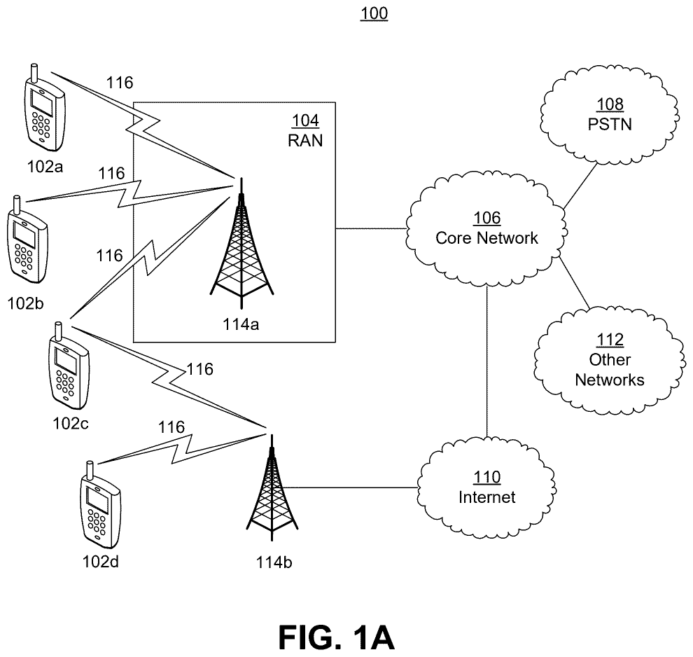

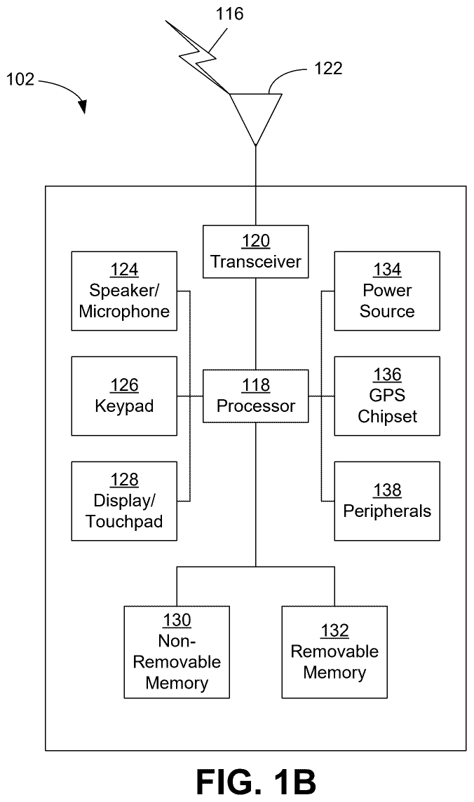

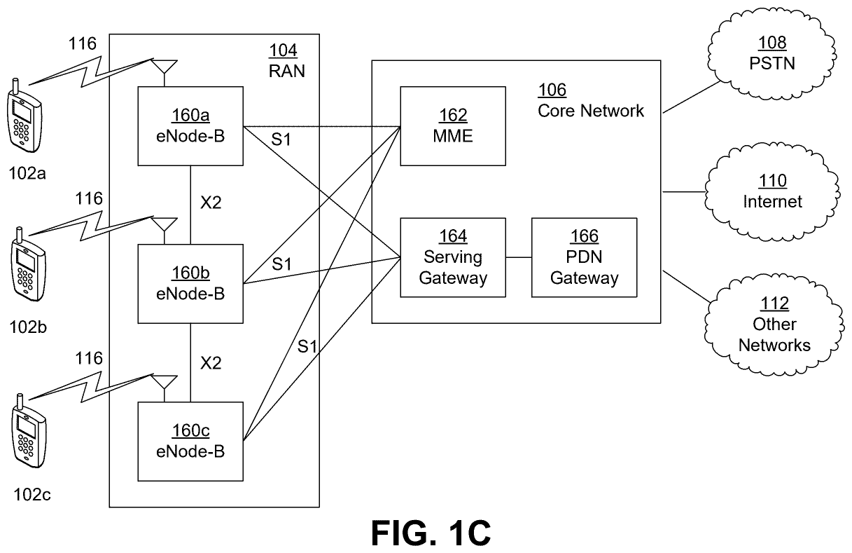

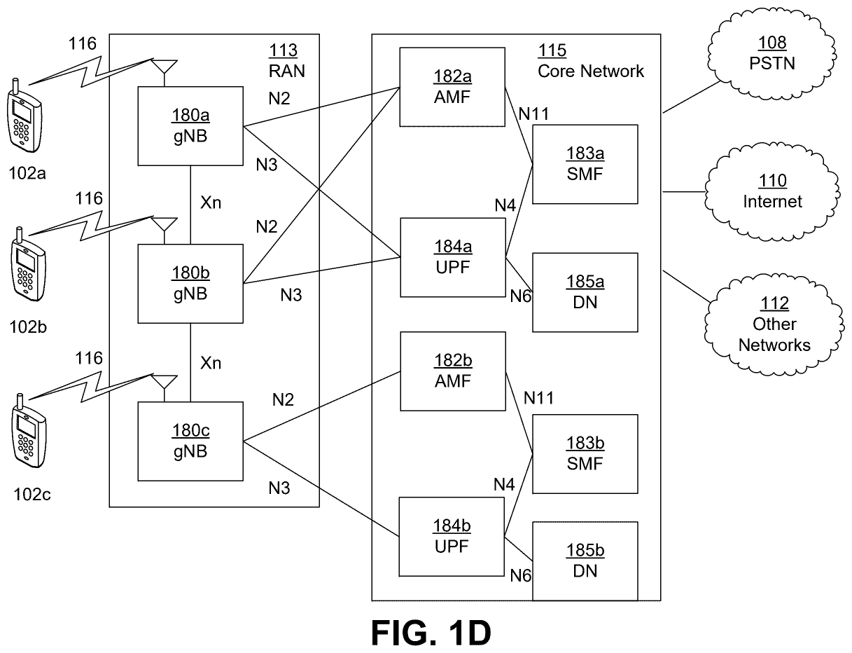

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An “AI-agent” may be an AI-enabled software (e.g. a reasoning engine) than helps automate and improves the quality of various tasks. Depending on the entity an AI-agent resides and the task that it is in charge of, there may be various types of AI-agents and each may play a different role in the task. For example, an AI-agent on the WTRU side may automatically make complex decisions on when to initiate a state change (e.g. from IDLE to Connected) and take the user location and activity pattern as its model input. Another AI-agent in the same WTRU may take care of the WTRU's energy saving strategies. For example, the AI-agent may decide when to turn off transceivers. An AI-agent in the core network Session Management Function may help achieve efficient resource allocation and load sharing. Another AI-agent in the User Plane function may help monitor and improve the communication quality of service (QoS).

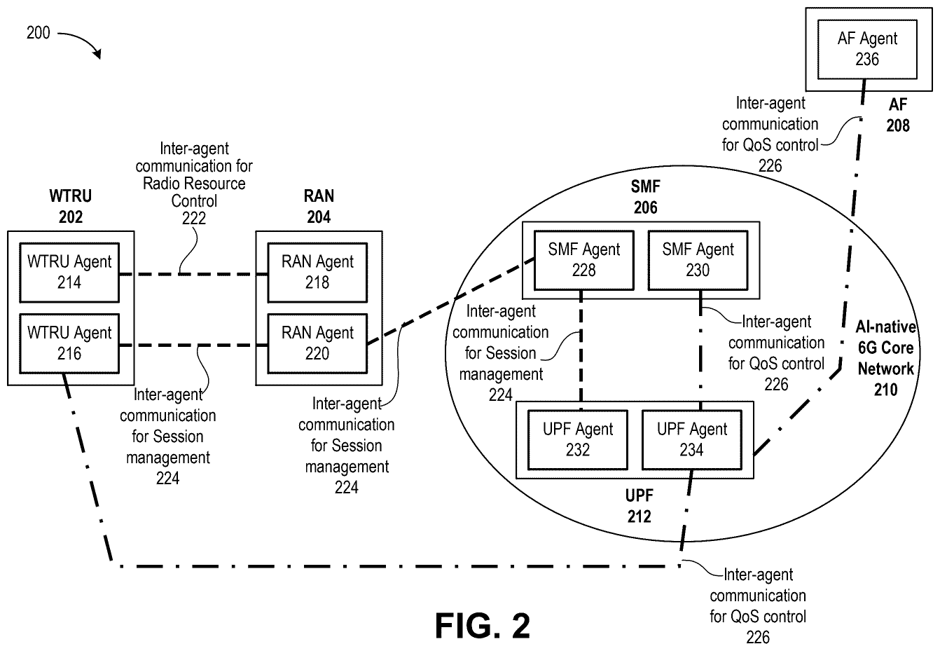

AI-agents in various entities of the network ecosystem may need to communicate and coordinate with each other to achieve their goals for various tasks. FIG. 2 illustrates an example framework 200 for inter-AI-Agent communication across the network ecosystem for various tasks. The framework 200 comprises WTRU 202, radio access network (RAN) 204, AI-native 6G core network 210, and/or application function (AF) 208. The AI-native 6G core network 210 may include session management function (SMF) 206 and/or user plane function (UPF) 212. For example, WTRU-agent 214 may interact with RAN-agent 218 for the purpose of more efficient radio resource control via inter-agent communication 222. WTRU-agent 216 may communicate with RAN-agent 220, SMF-agent 228 and UPF-agent 232 for session management for example, establishing or modifying a PDU Session, via inter-agent communication 224, WTRU-agent 216 may communicate with SMF-agent 230, UPF-agent 234 and AF-agent 236 for monitoring and improving QoS via inter-agent communication 226.

To enable Inter-AI-Agent communication across the network ecosystem for various tasks, various mechanisms may be established herein. For example, the various mechanisms may include mechanism for AI-agents in various entities to identify themselves and discover each other, for a specific task. The various mechanisms may include mechanism for AI-agents in various entities to establish connectivity so they can exchange information with each other. Inter-AI-agent communication may require speedy set-up and fast information exchange, but not necessarily have stringent requirement on reliability or seamlessness. The various mechanisms may include protocol for AI-agents to exchange information for various tasks.

Framework for Inter-AI-agent communication is discussed herein.

In various embodiments described herein, enablement of the interactions between the WTRU-side AI-agents and the CN-side AI-agents for various tasks may be discussed. The following principles may be proposed to facilitate a general framework for enabling the interactions between the WTRU-side AI-agents and the CN-side AI-agents for various tasks.

Multiple AI-agents may run at the WTRUs and different network entities (e.g., RAN, various network functions (NFs), AFs) for a common or joint task and these multiple AI-agents interact with each other to fulfill the common task.

The WTRUs, RAN, and/or core network functions (e.g., AMF, SMF, and/or UPF) may host multiple AI-agents for various tasks.

The AI-agents at the RAN or the core network functions may be WTRU-dedicated (e.g., serving a particular WTRU) or non-WTRU-dedicated (e.g., serving multiple WTRUs for the same task).

On the CN-side, an “AI-agent Anchor” function may be introduced to serve as the connection anchor between the WTRU-side AI-agents and the CN-side AI-agents.

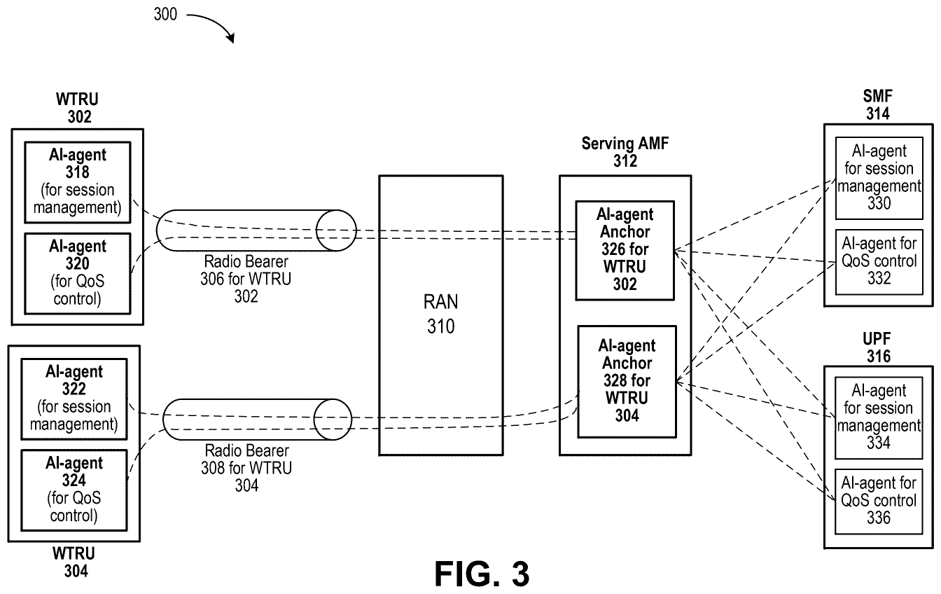

WTRU-dedicated AI-agent Anchors may be hosted by a network function that serves the WTRU, such as the WTRU's serving AMF, serving SMF or UPF. FIG. 3 illustrates an example procedure 300 of AI-agent Anchor hosted by the WTRU's serving access and mobility management function (AMF). The example procedure 300 includes WTRUs 302 and 304, radio bearers 306 and 308, RAN 310, serving AMF 312, SMF 314, and/or UPF 316. Both WTRU 302 and WTRU 304 may be connected via the same RAN 310 to the core network and are served by the same AMF 312. Multiple WTRU-side AI-agents 318, 320, 322 and 324 may have been created, e.g., for session management and QoS control tasks. For each WTRU 302 or 304, an AI-agent Anchor 326 or 328 may be allocated at its serving AMF 312 and the WTRU-side AI-agents 318, 320, 322 and 324 may communicate with other CN-side AI-agents 330, 332, 334 and 336 (e.g., those in SMF and UPF for session management and QoS control tasks) through the AI-anchors 326 and 328. The communication between the WTRU and AI-agent Anchor may be Control Plane-based, e.g., enabled by CP signaling connection such as NAS connection.

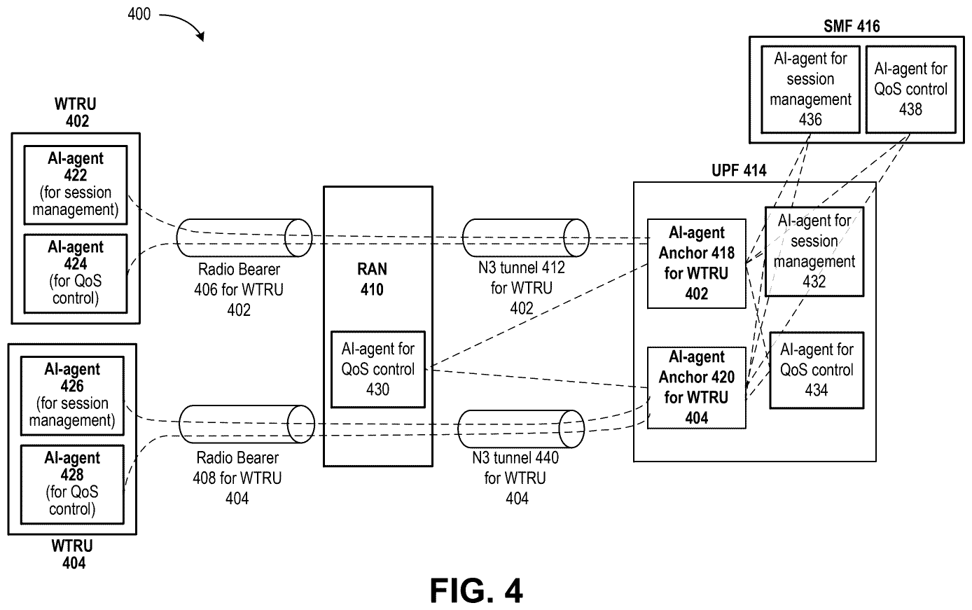

Similarly, FIG. 4 illustrates an example procedure 400 of the AI-agent Anchors hosted by the WTRU's UPF. The example procedure 400 includes WTRUs 402 and 404, radio bearers 406 and 408, RAN 410, N3 tunnels 412 and 440, UPF 414, and/or SMF 416. Both WTRU 402 and WTRU 404 may be connected via the same RAN 410 to the core network and are served by the UPF 414. Multiple WTRU-side AI-agents 422, 424, 426, and 428 may have been created, e.g., for session management and QoS control tasks. For each WTRU 402 or 404, an AI-agent Anchor 418 or 420 may be allocated at its UPF 414 and the WTRU-side AI-agents 422, 424, 426, and 428 may communicate with other CN-side AI-agents 432, 434, 436, and 438 (e.g., those in SMF and UPF for session management and QoS control tasks) through the AI-anchors 418 and 420. In this case, the communication between the WTRU and AI-agent Anchor is User Plane-based.

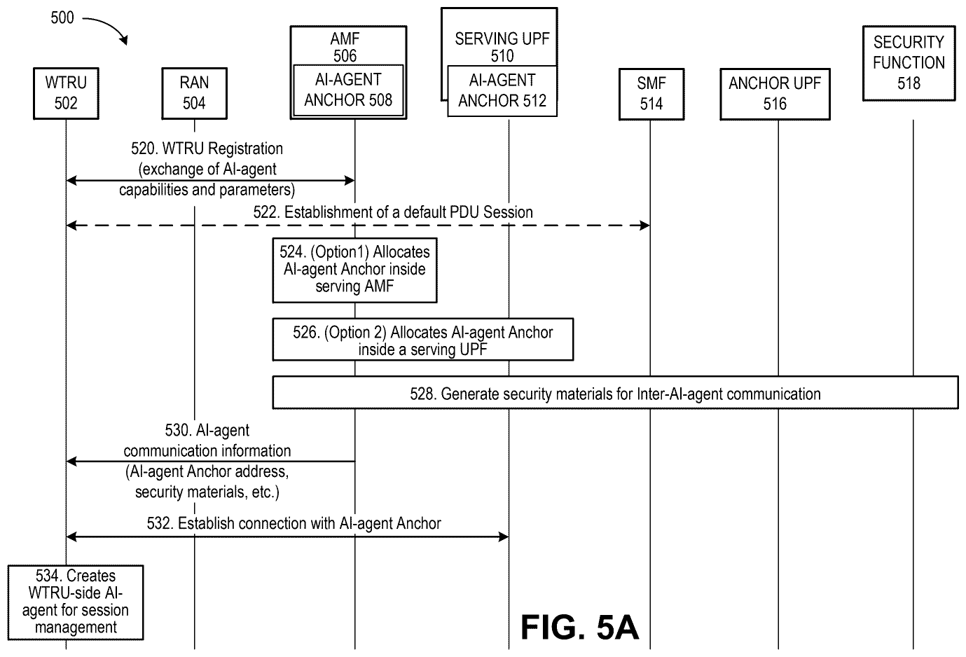

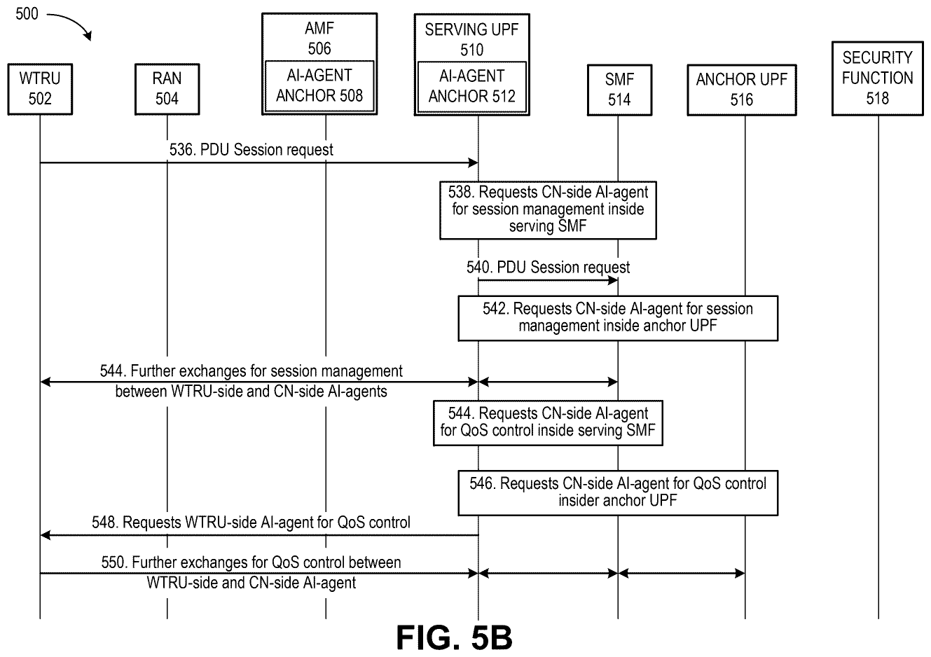

FIGS. 5A and 5B are flow charts to illustrate a high-level example procedure 500 in which the above principles are applied to enable interactions among AI-agents from WTRU-side and network-side for session management and QoS control. The example procedure 500 may include WTRU 502, RAN 504, AMF 506 with an AI-agent anchor 508, serving UPF 510 with an AI-agent anchor 512, SMF 514, anchor UPF 516, and/or security function 518.

At step 520, the WTRU 502 may register to the network (e.g., core network). During the Registration procedure, the WTRU 502 may indicate to the network its capability of supporting AI-agents. In other words, the WTRU 502 may send a registration request to the network. The registration request may indicate capability of the WTRU 502 to support one or more AI-agents. For example, the WTRU 502 may indicate what kind of tasks (e.g., session management, QoS control, etc.) that its AI-agents support, whether it supports inter-AI-agent communication for a common task, etc. Similarly, the network may inform the WTRU 502 of its support for AI-agent.

At step 522, if the inter-agent communication between the WTRU-side AI-agents and network-side AI-agents is going to be carried over User Plane (e.g., this step may not be necessary for the inter-agent communication over Control Plane), the WTRU 502 may initiate a default protocol data unit (PDU) Session establishment for the inter-agent communication/connection. The WTRU 502 may indicate in the PDU Session request that this PDU Session is for the purpose of inter-agent communication, and use a data network name (DNN) reserved for such purposes. The network may select a UPF that supports AI-agent communication (e.g., hosting an AI-agent Anchor) for this PDU Session.

At step 524, if the inter-agent communication is going to be performed over Control Plane, the network may allocate an AI-agent Anchor 508 within the control plane (CP) anchor such as the serving AMF 506. Alternatively, at 526, If the inter-agent communication is going to be performed over User Plane, the network may allocate an AI-agent Anchor 512 within the UPF 510 selected in step 522.

At step 528, the network may interact with other security functions in the network to generate security materials, such as token or certificate, for the integrity and confidentiality protection of future inter-agent communication.

At step 530, the network may inform the WTRU 502 of the AI-agent Anchor information and the WTRU 502 may receive the AI-agent anchor information from the network. The AI-agent anchor information may indicate that an AI-agent anchor residing in the network. For example, the AI-agent anchor information may include address and/or port associated with the AI-agent. The security materials, if available, may also be provided to the WTRU 502.

At step 532, the WTRU 502 may establish a connection, e.g., QUIC connection, with the AI-agent Anchor 512. The AI-agent anchor 512 may be a connection anchor between multiple WTRU-side AI-agents and multiple network-side AI-agents. The AI-agent anchor 512 may be hosted by an access and mobility management function (AMF) of the network, a user plane function (UPF) of the network, and/or a session management function (SMF) of the network. In some embodiments, the connection between the WTRU-side AI-agent and the AI-agent anchor may include a first connection between the WTRU-side AI-agent and an AI-agent hub, and a second connection between the AI-agent hub and the AI-agent anchor. The AI-agent hub may be a connection anchor between multiple WTRU-side AI-agents and the AI-agent anchor.

At step 534, the WTRU 502 may instantiate some WTRU-side AI-agent for a certain task. For example, as session management is needed for the WTRU's access to Data Networks, the WTRU 502 may instantiate an AI-agent for the task of session management.

At step 536, an application may be launched at the WTRU 502, which may trigger the WTRU 502 to request the establishment of a PDU Session for this application. Instead of normal PDU Session Request over non-access stratum (NAS) connection, the WTRU-side AI-agent for session control may send the request over the connection established in step 532 to the AI-agent Anchor 512. In other words, the WTRU 502 may send a protocol data unit (PDU) session request via the connection to the AI-agent anchor 512 using a WTRU-side AI-agent. The PDU session request may indicate a purpose of the connection and a reserved data network name (DNN) for the purpose.

At step 538, when the AI-agent Anchor 512 receives the PDU session request from the WTRU-side AI-agent, it may instantiate a corresponding network-side AI-agent for session management. The corresponding network-side AI-agent may be associated with the same task as the WTRU-side AI-agent. This network-side AI-agent may be hosted at the same UPF as the AI-agent Anchor. The network-side AI-agent may be hosted at other network functions (e.g., SMF or AI-agent Repository Function) and the AI-agent Anchor 512 may interact with those network functions to create the network-side AI-agent. In FIGS. 5A and 5B, the network-side AI-agent may be hosted in the SMF 514.

At step 540, if the network-side AI-agent for session management is hosted in other NFs (e.g., SMF), the AI-agent may forward the WTRU-side AI-agent's PDU Session request to the network-side AI-agent.

At step 542, the AI-agent Anchor 512 may determine that more NFs (e.g. UPF) need to be involved for the session management task and may request those NFs to create and host additional network-side AI-agents. The WTRU 502 may further receive network-side AI-agent information corresponding to the PDU session request from the network-side AI-agent. For example, the network-side AI agent information may include AI-agent ID and/or metadata associated with the network-side AI-agent.

At steps 544 and 546, the AI-agent Anchor 512 may determine that a different task related to the established PDU Session, e.g., QoS control, needs to be supported with AI-agents. It may request the NFs involved with QoS control to create and host AI-agents for QoS control.

At step 548, the AI-agent may request the WTRU 502 to create WTRU-side AI-agent for QoS control.

At step 550, The WTRU-side AI-agent for QoS control may communicate with the network-side AI-agent (e.g., through the AI-agent Anchor 512) to perform QoS control related activities, such as collecting QoS statistics from the WTRU-side AI-agent, adjust the resource control to improve the QoS, etc.

AI-agent instantiation, advertisement and discovery, as well as WTRU-side and network-side AI-agent instantiation may be discussed herein.

How AI-agents for various tasks are created or instantiated on WTRU side and network side (e.g., core network side), and how WTRU-side AI-agents and network-side AI-agents discover each other for their designated purposes, may be discussed herein.

WTRU-side AI-agent instantiation may be discussed herein. A WTRU that's capable of AI-agent-assisted communication may instantiate WTRU-side AI-agents for various tasks.

Some WTRU-side AI-agents may be created “semi-permanently”. For example, they may be automatically created and/or instantiated after the WTRU is powered-on and keep running until the WTRU is powered-off. For example, a WTRU-side AI-agent for complex power-saving decision purpose may be created this way. This AI-agent may keep monitoring user activities, WTRU locations, user environment, time information, and the like. This AI-agent may keep making power-saving related decisions, such as making the device enter or exit dormant mode, as long as the WTRU is powered-on. For another example, a WTRU-side AI-agent for WTRU's access state transition control purpose may be created this way. This AI-agent may keep monitoring the communication activity or inactivity, WTRU location, etc., to determine whether to enter connection management (CM)-Connected Mode or CM-IDLE mode.

Some WTRU-side AI-agents may be created “Conditionally”. For example, they may be instantiated when certain conditions are met or trigger events occur. For example, a WTRU-side AI-agent for session control in a particular network slice may be instantiated (e.g., only be instantiated) after the WTRU is Registered with the network, and the access to that particular network slide is allowed by the network. For another example, a WTRU-side AI-agent for QoS control purposes may be created (e.g., only be created) after a PDU Session or a QoS flow is created.

Some WTRU-side AI-agents may be created according to the network request. For example, the network may ask an AI-agent-capable WTRU to create a WTRU-side AI-agent for QoS control. Then the CN-side AI-agent for QoS control may interact with the WTRU-side AI-agent for QoS control to collect QoS monitoring information and modify communication parameters to improve the QoS. For another example, the network may ask an AI-agent-capable WTRU to create a WTRU-side AI-agent for positioning purpose, based on an incoming location service request. Then the CN-side AI-agent for positioning may interact with the WTRU-side AI-agent for positioning to collect and pre-process the positioning related measurements and produce the positioning results.

When a WTRU-side AI-agent is created or instantiated, an AI-agent Identifier (AIAGID) may be allocated to the AI-agent. AIAGID format may identify the WTRU that hosts the AI-agent. For example, the AIAGID may include the whole or a part of the WTRU identifier (e.g. globally unique temporary identifier (GUTI)). AIAGID may additionally identify a particular type of resource that the AI-agent is associated with. For example, the identifier of the AI-agent for the session management in a particular network slice may include the whole or a part of the network slice identifier. AIAGID may additionally indicate the task that it is designated for. For example, the AIAGID may include a “Task ID” that indicates a particular task (e.g., session control, QoS control, etc., see description of “task” below). AIAGID may identify an access type (e.g., 3rd Generation Partnership Project (3GPP) access or Non-3GPP access) that the AI-agent is associated with.

Each AI-agent may be associated with a set of metadata that provides information about the AI-agent. The AI-agent metadata may contain one or more of task information, artificial intelligence machine learning (AIML) model information, capability information, and/or connectivity information.

Task information may describe the task and/or purpose that the AI-agent is created for and specialized in handling. The examples of the tasks may include power saving, access state transition control, session management, QoS monitoring and control, traffic steering and switching, radio resource management, etc. For each supported task a “Task ID” may be allocated or standardized and understood across the ecosystem (i.e., WTRU, RAN, Core Network, Application, operation administration and management (OAM), etc.). An AI-agent may support multiple Task IDs.

AIML model information may include Model Identifier. The WTRU and the network may use this information to match the AIML models for a particular task. An AI-agent may support multiple AIML models.

Capability information may describe what the AI-agent is capable of. For example, the capability information of an AI-agent for positioning purposes may indicate what type of measurements it supports, the precision or quality of the measurements, whether it supports pre-processing of the measurements, whether it supports producing positioning results, etc.

Connectivity information may include internet protocol (IP) address/port, transport protocol and version (e.g. quick user datagram protocol (UDP) internet connection (QUIC)), QUIC connection IDs, etc.

CN-side AI-agent Instantiation may be discussed herein.

On the CN-side, the instantiation of AI-agents may be controlled by the AI-agent Anchor. The AI-agent may monitor the WTRU activities and determine what AI-agents might be needed or beneficial to the WTRU's tasks, and/or instantiate the AI-agents in various network nodes and entities accordingly. For example, the AI-agent may monitor NAS messages if the AI-agent Anchor is CP-based. For another example, the AI-agent may monitor the messages over the QUIC connection between the WTRU and AI-agent Anchor if the anchor is UP-based.

For example, as shown above in FIGS. 5A and 5B, when the AI-agent Anchor 512 detects that the WTRU 502 is requesting the establishment of a PDU Session, the anchor 512 may determine AI-agents for session management at selected SMF 514 and UPF 516 may be needed so it requests the selected SMF and UPF to instantiate the AI-agents for session management. After the PDU Session is successfully established, the AI-agent Anchor 512 may determine that AI-agents for QoS control are needed, so it requests the selected SMF 514, UPF 516, RAN node 504 and WTRU 502 to instantiate the AI-agents for QoS control.

Similar to WTRU-side AI-agents, an AI-agent in a network or RAN node may also be allocated an AIAGID and associated with a set of metadata.

Alternatively, the instantiation of AI-agents at various network nodes may be controlled by the network node itself. For example, when an AI-agent capable SMF receives a PDU Session requests, and the requesting WTRU indicates that the WTRU-side AI-agent for session management or QoS control is available, the SMF may determine to instantiate its own AI-agents so its AI-agents may cooperate with the WTRU-side AI-agents to assist session management or QoS control. If the AI-agents are WTRU-dedicated, the WTRU identifiers may be provided to the involved network functions so they can associate the instantiated AI-agents with the WTRU.

AI-agent information advertisement and mutual discovery may be discussed herein.

For the AI-agents in various entities (WTRU-side, RAN-side, CN-side, etc.) to cooperate with each other to assist its tasks, they may need to discover each other.

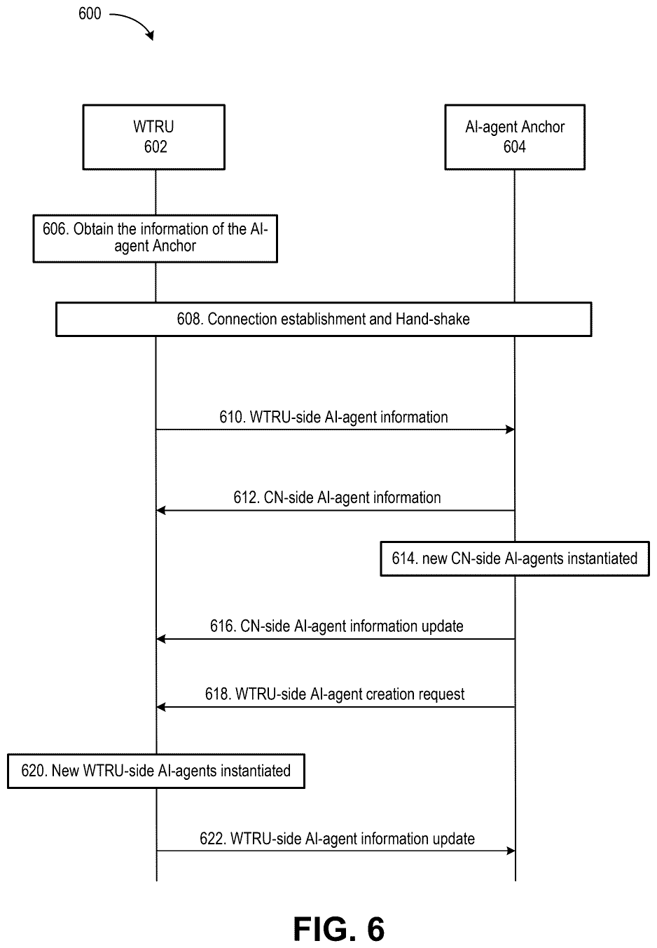

In case that there is an AI-agent anchor on the CN-side, which manages various CN-side AI-agents, the WTRU may discover the AI-agent Anchor first. After the WTRU has established the connection with the AI-agent Anchor, they may exchange the WTRU-side and CN-side AI-agent information over the connection. FIG. 6 is a flow chart to illustrate an example procedure 600 of AI-agent information exchange via AI-agent anchor.

At step 606, the WTRU 602 may obtain from the CN its AI-gent Anchor information (e.g. the IP address and port information). The WTRU 602 may obtain this information from its serving AMF via NAS message, as shown in step 530 of FIG. 5A.

At step 608, using the obtained AI-agent Anchor information, the WTRU 602 may initiate the connection establishment with the AI-agent Anchor 604. If the AI-agent Anchor 604 is hosted by a CP node (e.g., serving AMF), the WTRU 602 may use the existing NAS connection to communicate with the AI-agent Anchor 604, therefore, this step may be omitted. If the AI-agent Anchor 604 is hosted by a user plane (UP) node (e.g., an UPF close to the network edge), the WTRU 602 may establish the connection with the anchor 604 using appropriate technology such as QUIC protocol. This connection may be established over a default bearer or PDU Session between the WTRU 602 and the network.

After the connection is established, the WTRU 602 and the AI-agent Anchor 604 may perform a hand-shake procedure. For example, the WTRU 602 and the anchor 604 may exchange its AI-agent related capability information such as supported task IDs, supported models, number of AI-agents, supported security methods, etc. The anchor 604 may also authenticate and authorize the WTRU 602 for the purpose of using AI-agent and establish security associations.

At step 610, if the WTRU 602 has instantiated AI-agents, it may inform the anchor 604 the WTRU-side AI-agent information, such as AI-agent IDs and its associated metadata.

At step 612, if the CN has instantiated AI-agents, either WTRU-dedicated or non-WTRU-dedicated, it may inform the WTRU 602 the CN-side AI-agent information, such as AI-agent IDs and its associated metadata.

At step 614, the CN may instantiate a new AI-agent for a certain task.

At step 616, the AI-agent Anchor 604 may inform the WTRU 602 about the change of the CN-side AI-agent information.

At step 618, if the CN or the anchor determines that some WTRU-side AI agent needs to be created, it may request the WTRU 602 to do so. The anchor 604 may provide the task ID and other information (e.g. the model to be used by the requested AI-agent) according to the WTRU's capabilities for the requested AI-agent.

At step 620, the WTRU may instantiate new AI-agents upon the request of the network.

At step 622, the WTRU may inform the CN about the change of the WTRU-side AI-agent information.

There may be other changes to the WTRU-side or CN-side AI-agent, such as that an AI-agent is destroyed or its metadata information has changed (e.g. using a different model, etc.), and the WTRU and the AI-agent Anchor may use the above procedure to synchronize with each other.

In another method, the network may have one or multiple AI-Agent Repositories that host the CN-side AI-Agents. The main functionality of an AI-Agent Repository may be to create and store CN-side AI-Agents and manage the lifecycle of the AI-Agents. Each Repository may be serving a specific area or a specific network slice. The information of the available AI-Agents in an AI-Agent Repository may be retrieved by other network functions such as AMF, UPF, etc., or pushed to those network functions. When a WTRU accesses the network and interact with those functions it may obtain the CN-side AI-agent information through those network functions. Alternatively, if the WTRU has direct access to the service based interface (SBI) bus and can direct access the AI-Agent Repositories via SBI interface, the WTRU may directly invoke the AI-Agent Repository service to obtain the AI-agent information.

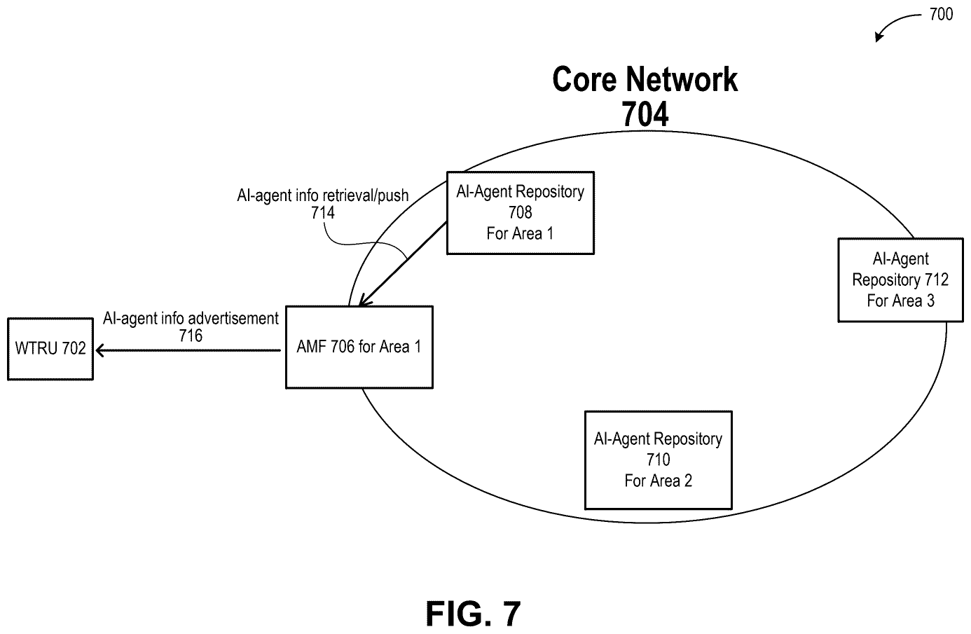

FIG. 7 illustrates an example procedure 700 of AI-agent repository. FIG. 7 may comprise a WTRU 702 and a core network 704. The core network 704 may include multiple AI-agent repositories 708, 710, and 712 and AMF 706, with AI-agent repository 708 serving Area 1, AI-agent repository 710 serving Area 2, AI-agent repository 712 serving Area 3 and AMF 706 serving Area 1. AMF 706 may retrieve the network side AI-agent information from AI-agent repository 708, and/or AI-agent repository 708 may push the retrieve the network side AI-agent information to AMF 706.

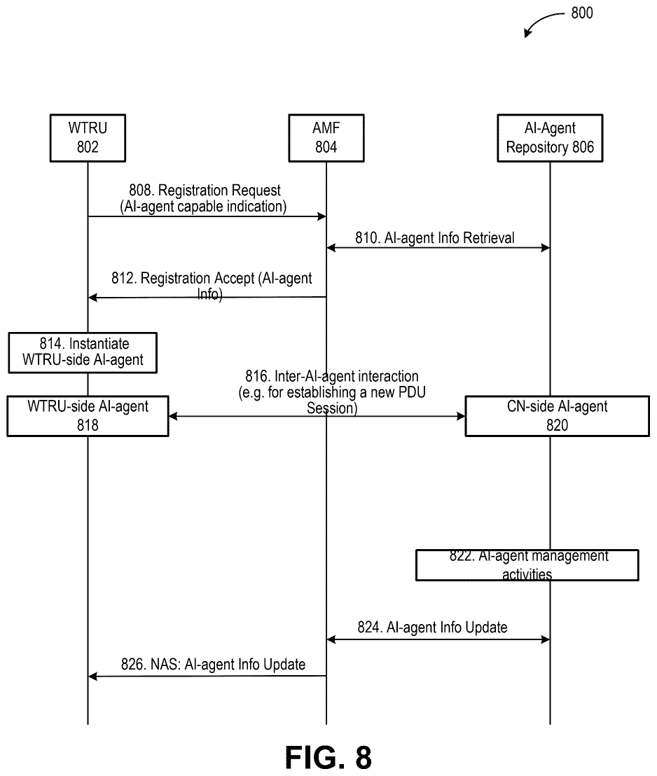

FIG. 8 is a flow chart to illustrate an example procedure 800 on how the WTRU obtain AI-agent information (e.g., CN-side AI-agent information) from the AI-agent Repository.

At step 808, the WTRU 802 may perform Registration procedure with the network. In the Registration Request the WTRU 802 may indicate it is capable of AI-Agent communication.

At step 810, the AMF 804 may allocate the AI-agent Repository 806 in the network (e.g., by querying the network repository function (NRF) which is not shown) and retrieve the information of the AI-agents available in the AI-agent Repository 806. The AI-agent information may include the AI-agent ID and its associated metadata. Note that the connectivity information (e.g., IP address, port) of the AI-agents managed by the same AI-agent Repository may be different.

At step 812, the AMF 804 may provide the retrieved AI-agent information to the WTRU 802, e.g., in Registration Accept message.

At step 814, according to the received CN-side AI-agent information, the WTRU 802 may determine to instantiate corresponding WTRU-side AI-agents 818. The corresponding WTRU-side AI-agent may be associated with the same task as the CN-side AI-agent 820. For example, if the received CN-side AI-agent information indicates there is CN-side AI-agent 820 for session management available, the WTRU 802 may create a corresponding WTRU-side AI-agent 818 for session management.

At step 816, the WTRU-side AI-agent 818 may start to establish the connection to the corresponding CN-side AI-agent 820 for a task. For example, the WTRU-side AI-agent 818 may interact with the CN-side AI-agent 820 for establishing a new PDU Session.

At step 822, the AI-agent information in the Repository 806 may change due to various AI-agent management activities. For example, some new AI-agents may be created, some AI-agents may be destroyed, some AI-agents may be upgraded (e.g. using a more advanced model), etc.

At step 824, the update of AI-agent information may be pushed by the AI-agent Repository 806 to the network functions.

At step 826, the update of AI-agent information may be provided to the WTRU 802 by the network functions.

Connectivity establishment for inter-agent communication may be discussed herein. Inter-agent connection models may be discussed herein

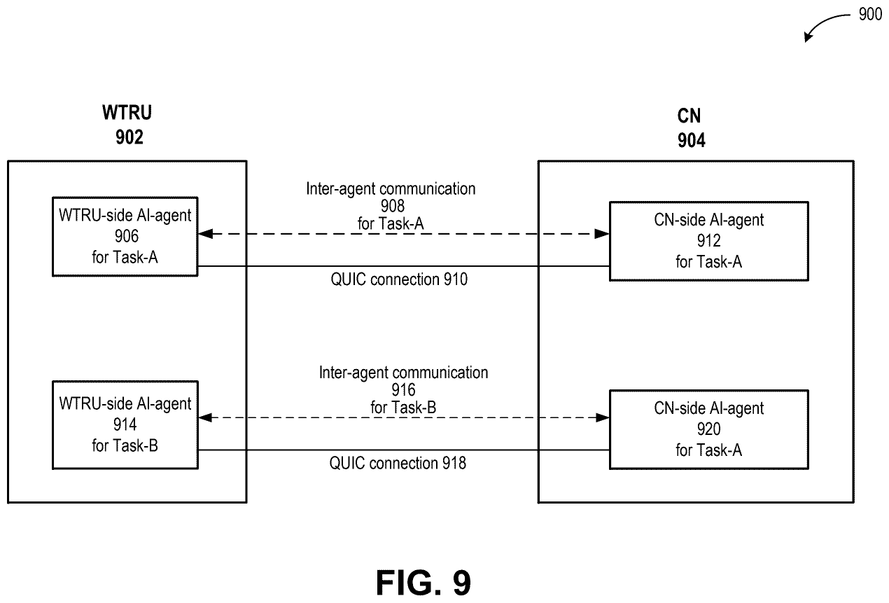

FIG. 9 illustrates an example procedure 900 of direct inter-agent connection. The example procedure 900 may include WTRU 902 and core network 904. In Direct Connection model, each pair of AI-agents (e.g., a WTRU-side AI-agent and a CN-side AI-agent for a common task) 906 and 912 or 914 and 920 may establish an inter-agent connection 908 and/or 916 (e.g. QUIC connections 910 and/or 918) and exchange messages/information directly over the connection 908 and/or 916. Each WTRU-side AI-agent 906 and/or 914 may have its own IP address and port for inter-agent connection 908 and 916 and may discover the peer CN-side AI agent's IP address/port through the advertisement/discovery procedure described above.

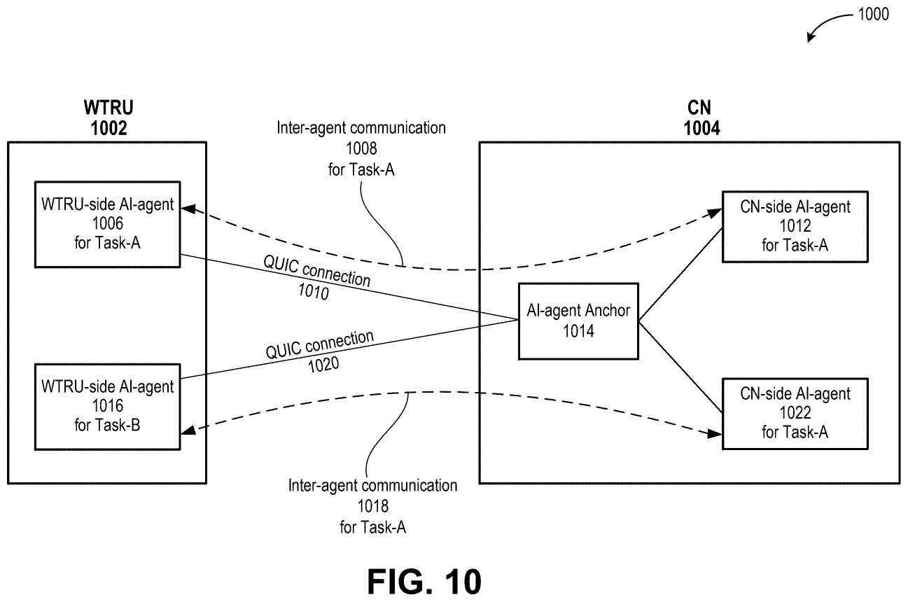

FIG. 10 illustrates an example procedure 1000 of indirect inter-agent connection via AI-agent anchor. The example procedure 1000 may include WTRU 1002 and core network 1004. In Indirect Connection model, the CN-side may have an AI-agent Anchor 1014, and communication (e.g., all the communication) with the CN-side AI-agents 1012 and 1022 may be through the AI-agent Anchor 1014. The AI-agent Anchor 1014 may be WTRU-dedicated, that each WTRU 1002 may be allocated a dedicated AI-agent Anchor 1014. The WTRU 1002 may establish a connection (e.g., QUIC connection 1010 and/or 1020) via WTRU-side AI-agent 1006 and 1016 with the AI-agent Anchor 1014 and have inter-agent communication 1008 and 1018 with CN-side AI-agents 1012 and 1022 through the anchor 1014. In one example, the AI-agent Anchor may be non-WTRU-dedicated and multiple WTRUs may share the same anchor. Non-WTRU-dedicated AI-agent Anchor may serve a specific area or a specific network slice.

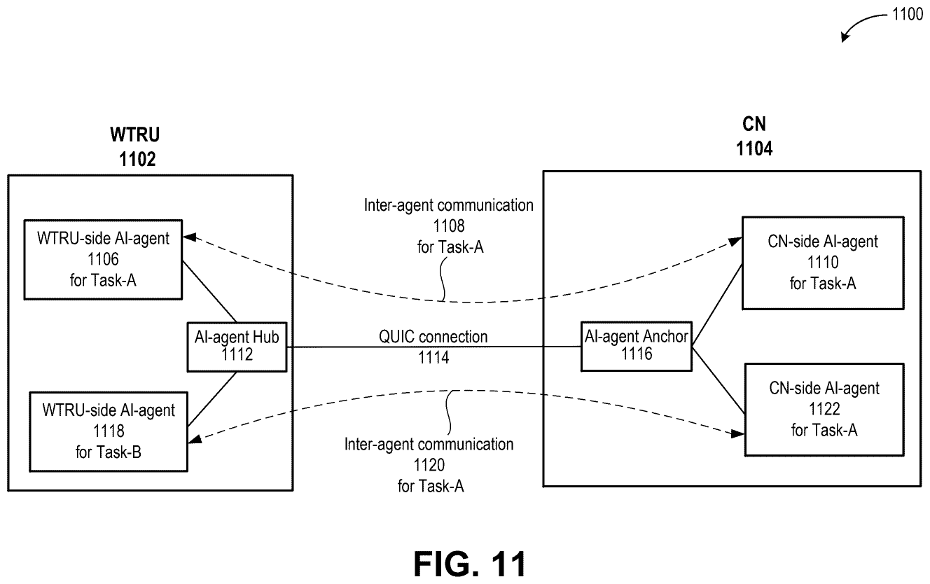

FIG. 11 illustrates an example procedure 1100 of indirect inter-agent connection via AI-agent hub and AI-agent anchor. The example procedure 1100 may include WTRU 1102 and core network 1104. Similarly, on the WTRU side there may exist an AI-agent Hub function 1112. The communication 1108 and 1120 with the WTRU-side AI-agents (e.g., all the WTRU-side AI-agents) 1106 and 1108 may be through the AI-agent Hub 1112. The WTRU-side AI-agent Hub 1112 and the CN-side AI-agent Anchor 1116 may establish a connection (e.g., QUIC connection 1114) and the inter-agent communication (e.g., all the inter-agent communication) 1108 and 1120 between WTRU-side AI-agent 1106 and 1118 and CN-side AI-agent 1110 and 1122 may be carried over the connection 1114.

When the WTRU-side AI-agents and CN-side AI-agents communicate with each other over the connection, the initiating AI-agent may identify the peer agent using the AIAGID information obtained during the discovery process described above. Alternatively, the initiating AI-agent may indicate the task ID in the messages and the WTRU or the AI-agent Anchor may locate the corresponding AI-agents associated with the task.

PDU session for inter-agent connection may be discussed herein.

To enable Inter-agent connections, the WTRU may establish a default PDU Session for Inter-agent Communication. The inter-agent connection/communication (e.g., all the inter-agent connection/communication) may be carried by this default PDU Session. Note that the purpose of this default PDU Session may not be for the connectivity to a particular Data Network, as what a normal PDU Session does. A special Data Network Name (DNN) may be reserved for Inter-agent Communication and the WTRU may indicate this special DNN in its PDU Session Establishment request. The network may select a UPF that is capable of hosting AI-agent Anchor for this PDU Session.

The inter-agent connection and/or communication (e.g., all the inter-agent connection and/or communication) may share the same PDU Session established for this purpose, or multiple PDU Sessions may be established for inter-agent connection/communication. For example, some AI-agents may share the same PDU Session and another AI-agents may use its dedicated PDU Sessions.

For WTRU-side AI-agents without AI-agent Hub, each AI-agent that needs inter-agent communication is assigned to a PDU Session established for this purpose. The AI-agent may use the IP address allocated for the PDU Session as its own IP address for the connections with the CN-side AI-agents or AI-agent Anchor. For WTRU-side AI-agents with AI-agent Hub, the AI-agent Hub may be the entity that establishes and maintains the PDU Session for inter-agent communication and forwards the messages/information between the WTRU-side AI-agents and the network over this PDU Session.

1. A wireless transit/receive unit (WTRU) comprising:
a processor and a memory, wherein the processor is configured to:
send a registration request to a network, wherein the registration request indicates capability of the WTRU to support one or more artificial intelligence (AI) agents;
receive AI-agent anchor information from the network, wherein the AI-agent anchor information indicates an AI-agent anchor residing in the network;
establish a connection with the AI-agent anchor;
send a protocol data unit (PDU) session request via the connection to the AI-agent anchor using a WTRU-side AI-agent, wherein the PDU session request indicates a purpose of the connection and a reserved data network name (DNN) for the purpose; and
receive network-side AI-agent information corresponding to the PDU session request from a network-side AI-agent, wherein the network-side AI agent information comprises AI-agent ID or metadata associated with the network-side AI-agent.

2. The WTRU of claim 1, wherein the registration request indicates a task that is supported by the WTRU or that the WTRU supports an inter-agent communication.

3. The WTRU of claim 1, wherein the processor is further configured to initiate a default PDU session establishment for an inter-agent communication.

4. The WTRU of claim 1, wherein the AI-agent anchor information comprises an address associated with the AI-agent or security information.

5. The WTRU of claim 1, wherein the AI-agent anchor is a connection anchor between multiple WTRU-side AI-agents and multiple network-side AI-agents.

6. The WTRU of claim 1, wherein the AI-agent anchor is hosted by an access and mobility management function (AMF) of the network, a user plane function (UPF) of the network, or a session management function (SMF) of the network.

7. The WTRU of claim 1, wherein the connection between the WTRU-side AI-agent and the AI-agent anchor is a quick user datagram protocol (UDP) internet connection (QUIC).

8. The WTRU of claim 1, wherein the connection between the WTRU-side AI-agent and the AI-agent anchor comprises a first connection between the WTRU-side AI-agent and an AI-agent hub, and a second connection between the AI-agent hub and the AI-agent anchor.

9. The WTRU of claim 8, wherein the AI-agent hub is a connection anchor between multiple WTRU-side AI-agents and the AI-agent anchor.

10. The WTRU of claim 1, wherein the processor is configured to:
receive a request from the network to create a second WTRU-side AI-agent for quality of service (QoS) control; and
communicate with a second network-side AI-agent to perform QoS control activities.

11. A method comprising:
sending a registration request to a network, wherein the registration request indicates capability of a wireless transit/receive unit (WTRU) to support one or more artificial intelligence (AI) agents;
receiving AI-agent anchor information from the network, wherein the AI-agent anchor information indicates an AI-agent anchor residing in the network;
establishing a connection with the AI-agent anchor;
sending a protocol data unit (PDU) session request via the connection to the AI-agent anchor using a WTRU-side AI-agent, wherein the PDU session request indicates a purpose of the connection and a reserved data network name (DNN) for the purpose; and
receiving network-side AI-agent information corresponding to the PDU session request from a network-side AI-agent, wherein the network-side AI agent information comprises AI-agent ID or metadata associated with the network-side AI-agent.

12. The method of claim 11, wherein the registration request indicates a task that is supported by the WTRU or that the WTRU supports an inter-agent communication.

13. The method of claim 11, further comprising:
initiating a default PDU session establishment for an inter-agent communication.

14. The method of claim 11, wherein the AI-agent anchor information comprises an address associated with the AI-agent or security information.

15. The method of claim 11, wherein the AI-agent anchor is a connection anchor between multiple WTRU-side AI-agents and multiple network-side AI-agents.

16. The method of claim 11, wherein the AI-agent anchor is hosted by an access and mobility management function (AMF) of the network, a user plane function (UPF) of the network, or a session management function (SMF) of the network.

17. The method of claim 11, wherein the connection between the WTRU-side AI-agent and the AI-agent anchor is a quick user datagram protocol (UDP) internet connection (QUIC).

18. The method of claim 11, wherein the connection between the WTRU-side AI-agent and the AI-agent anchor comprises a first connection between the WTRU-side AI-agent and an AI-agent hub, and a second connection between the AI-agent hub and the AI-agent anchor.

19. The method of claim 18, wherein the AI-agent hub is a connection anchor between multiple WTRU-side AI-agents and the AI-agent anchor.

20. A network entity comprising:
a processor configured to:
receive a registration request from a wireless transit/receive unit (WTRU), wherein the registration request indicates capability of the WTRU to support one or more artificial intelligence (AI) agents;
send an AI-agent anchor information to the WTRU, wherein the AI-agent anchor information indicates an AI-agent residing in the network;
receive a connection with the AI-agent anchor;
receive a PDU session request from the WTRU via the connection to the AI-agent anchor using a WTRU-side AI-agent, wherein the PDU session request indicates a purpose of the connection and reserve a data network name (DNN) for the purpose; and
send a network-side AI-agent information corresponding to the PDU session request to the WTRU from the network-side AI-agent, wherein the network-side AI agent information comprises AI-agent ID or metadata associated with the network-side AI-agent.
